(19) United States
(12) Patent Application Publication
(10) Pub. No.: US 2005/0278176 A1
(43) Pub. Date: Dec. 15, 2005

(54) Hand held pocket pal

(76) Inventor: Jameel Yusuf Ansari, Coatesville, PA (US)

Correspondence Address: Jameel Yusuf Ansari, 9 Donna Drive, Coatesville, PA, 19320, US

(21) Appl. No.: 10/954,126

(22) Filed: Dec. 30, 2004

Related U.S. Application Data
(60) Provisional application No. 60/578,380, filed on Jun. 10, 2004.

(51) Int. Cl. G10L 15/04

(52) U.S. Cl. 704/251

(57) ABSTRACT

This device is designed to stimulate the pursuit of knowledge and breakdown the “wall of inadequacy” for people of any age. This device will give the user the meaning of a word or “jargon” instantly—by merely repeating the sound of the word the user has just heard into the microphone of the devise. The meaning of the word will be given to the user of this devise by sight, i.e., reading it on the device's screen, or hearing it from the device's built-in speaker via the “voice” sound-module contained in the device. The device will give a word's antonym, synonym and the meaning of words and phrases of 11 different Languages. Additionally, the devise will give academically recommended literary speeches, poems, sayings and mathematical terms and formulas with “how-to” tutorial explanations.

### CROSS-REFERENCE TO RELATED APPLICATIONS

“Not Applicable”

### STATEMENT REGARDING FEDERALLY SPONSORED RESEARCH OF DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

1. Field of Invention

This invention is in the area of ‘hand held electronic’ devices, such as the “Black Berry”, “Palm Pilot” and Electronic Dictionaries.

2. Description of Prior Art

Prior devices have focused on academically oriented users designed to facilitate current pursuits such as students and professional academics, mainly, looking up a words—antonyms, synonyms, or as a thesaurus. However, this is unhelpful or at least turns-off people who may have stopped their formal studies either recently or years ago due, more often than not, to a negative school experience. These people often didn't get individual attention in school or didn't have someone at home to help them and tutorial services can be very expensive.

### BRIEF SUMMARY OF THE INVENTION

This device is designed to stimulate the pursuit of knowledge. To breakdown the “wall of inadequacy” that most people fell when confronted with “big” words, whether encountered when engaged in conversation, listening to a lecture or formal “talk”, reading, or while watching TV. This device will give the user the meaning of a word or “jargon” instantly—by only repeating the sound of the word the user has just heard—the meaning of the word will be given to the user of this devise by sight, i.e., reading it on the device's screen or hearing it from the “voice” sound-module contained in the device. So the user doesn't have to know, before hand, how to spell a word, which is the main impediment to people using dictionaries, plus the time it takes to look up a word in the dictionary.

### BRIEF DESCRIPTION OF THE SEVERAL VIEWS OF THE DRAWING

“Not Applicable” Drawings were submitted previously

### DETAILED DESCRIPTION OF THE INVENTION

This device is basically similar in appearance to other the hand-held electronic devices, in that it has several buttons which is the primary way the user accesses the value-features of the device, i.e., Stored Dictionary and Thesaurus of antonyms and synonyms; Stored historical events and dates, Stored Acacemically recommended literary speeches, poems, sayings; Stored mathematical terms and formulas with “how-to” tutorial explanations; Stored two-way translations between English, French, German, Spanish, Russian, Japanese, Arabic, Hindi and Chinese. The two-way translation will be given for words and sentences such as “How much does this cost?” or “What is your name?” and “Where can I get some food?.” The “Two-way” process will allow a person to select the user's language and then select the desired translated language, say from English to French or from French to English, or from French to German or German to French.

All data will be stored in this device's memory which has an audio module to allow the information to be given to the user via a stored recorded voice and well as to be printed on the device's screen.

This device has a small number-letter keyboard on the face of the device, which allows the user the option of typing in a word or sentence. This device also has a receiver to allow the user to speak into the device. The device's memory module has a phonetic word translator module which allows the user to get the definition of a word or sentence without having to first type-in the word or sentence.

The device gets its operating power from a built-in rechargeable battery and will come with battery charger.

1. I claim that the HAND HELD POCKET PAL invention will make possible the instant understanding of the spoken word with one-hundred percent comprehension in the most timely, cost efficient and personally comfortable manner possible. It will eliminate the need to take time to look-up a word in the dictionary—especially if one is not sure of the correct spelling.
